(19) United States
(12) Patent Application Publication
(10) Pub. No.: US 2026/0044593 A1
(43) Pub. Date: Feb. 12, 2026

(54) ELECTRONIC DEVICE FOR PROVIDING TARGET APPLET BY VERIFYING APPLET AND OPERATING METHOD THEREOF

(71) Applicant: Samsung Electronics Co., Ltd., Suwon-si (KR)

(72) Inventors: Gawon LEE, Suwon-si (KR); Seunghyeon CHO, Suwon-si (KR); Donghoon LEE, Suwon-si (KR); Daehaeng CHO, Suwon-si (KR); Hakhyun KIM, Suwon-si (KR); Hyungchul JUNG, Suwon-si (KR)

(21) Appl. No.: 19/251,226

(22) Filed: Jun. 26, 2025

Related U.S. Application Data
(63) Continuation of application No. PCT/KR2025/007142, filed on May 27, 2025.

(30) Foreign Application Priority Data
Aug. 6, 2024 (KR) 10-2024-0104594
Oct. 22, 2024 (KR) 10-2024-0144933

(51) Int. Cl. G06F 21/44; H04L 9/32

(52) U.S. Cl. CPC G06F 21/44; H04L 9/3242

(57) ABSTRACT

Disclosed are an electronic device for providing a target applet by verifying an applet and an operating method thereof. An electronic device includes: at least one host processor and a secure element (SE) electrically connected to the at least one host processor, wherein the SE includes at least one processor including processing circuitry and memory storing instructions that, when executed by the at least one processor individually or collectively, cause the electronic device to transmit, to an operating system (OS) of the SE, a request for a target applet to be used by an applet, provide an instance to the applet in response to the request for the target applet, generate authentication data for the target applet in the applet and transmit the authentication data to the target applet, and determine whether to provide a function of the target applet to the applet by verifying the authentication data in the target applet.

### CROSS-REFERENCE TO RELATED APPLICATIONS

This application is a continuation of International Application No. PCT/KR2025/007142 designating the United States, filed on May 27, 2025, in the Korean Intellectual Property Receiving Office and claiming priority to Korean Patent Application No. 10-2024-0104594, filed on Aug. 6, 2024, and Korean Patent Application No. 10-2024-0144933, filed on Oct. 22, 2024, in the Korean Intellectual Property Office, the disclosures of which are incorporated by reference herein in their entireties.

### BACKGROUND

### 1. Field

The disclosure relates to an electronic device for providing a target applet by verifying an applet and an operating method thereof.

### 2. Description of Related Art

To protect personal information, electronic devices may use security features to provide services that require security. For example, an electronic device may include a secure element (SE) (e.g., an embedded SE (eSE)). The electronic device may provide a user with experiences for services (e.g. digital keys, electronic banking, or electronic payments) requiring high security through SEs. An SE may include one or more applets and provide various services to a user through execution of the applets.

The above information may be presented as the related art to help with the understanding of the disclosure. No assertion or determination is made to whether any of the above description is applicable as the prior art related to the present disclosure.

### SUMMARY

According to an example embodiment, an electronic device includes: at least one host processor, comprising processing circuitry. The electronic device includes a secure element (SE) comprising processing circuitry electrically connected to the at least one host processor. The SE includes memory storing instructions. The SE includes at least one processor comprising processing circuitry. The at least one processor, individually or collectively, is configured to execute the instructions and to cause the electronic device to transmit, to an operating system (OS) of the SE, a request for a target applet to be used by an applet. The at least one processor, individually or collectively, is configured to execute the instructions and to cause the electronic device to provide an instance to the applet in response to the request for the target applet. The at least one processor, individually or collectively, is configured to execute the instructions and to cause the electronic device to generate authentication data for the target applet in the applet and transmit the authentication data to the target applet. The at least one processor, individually or collectively, is configured to execute the instructions and to cause the electronic device to determine whether to provide a function of the target applet to the applet by verifying the authentication data in the target applet.

According to an example embodiment, a secure element (SE) includes memory storing instructions. The SE includes at least one processor, comprising processing circuitry. The at least one processor, individually or collectively, is configured to execute the instructions and to cause the electronic device to transmit, to an operating system (OS) of the SE, a request for a target applet to be used by an applet. The at least one processor, individually or collectively, is configured to execute the instructions and to cause the electronic device to provide an instance to the applet in response to the request for the target applet. The at least one processor, individually or collectively, is configured to execute the instructions and to cause the electronic device to generate authentication data for the target applet in the applet and transmit the authentication data to the target applet. The at least one processor, individually or collectively, is configured to execute the instructions and to cause the electronic device to determine whether to provide a function of the target applet to the applet by verifying the authentication data in the target applet.

According to an example embodiment, a method of operating an electronic device includes: transmitting, to an operating system (OS) of a secure element (SE), a request for a target applet to be used by an applet. The method includes providing an instance to the applet in response to the request for the target applet. The method includes generating authentication data for the target applet in the applet and transmitting the authentication data to the target applet. The method includes determining whether to provide a function of the target applet to the applet by verifying the authentication data in the target applet.

According to an example embodiment, a method of operating a secure element (SE) includes: transmitting, to an operating system (OS) of the SE, a request for a target applet to be used by an applet. The method includes providing an instance to the applet in response to the request for the target applet. The method includes generating authentication data for the target applet in the applet and transmitting the authentication data to the target applet. The method includes determining whether to provide a function of the target applet to the applet by verifying the authentication data in the target applet.

According to an example embodiment, a non-transitory computer-readable storage medium stores one or more computer programs including instructions that when executed by at least one processor, comprising processing circuitry, individually and/or collectively, of an electronic device, causes the electronic device to perform operations comprising transmitting, to an operating system (OS) of a secure element (SE), a request for a target applet to be used by the applet. The non-transitory computer-readable storage medium stores one or more computer programs including instructions that when executed by at least one processor, comprising processing circuitry, individually and/or collectively, of an electronic device, causes the electronic device to perform operations comprising providing an instance to the applet in response to the request for the target applet. The non-transitory computer-readable storage medium stores one or more computer programs including instructions that when executed by at least one processor, comprising processing circuitry, individually and/or collectively, of an electronic device, causes the electronic device to perform operations comprising generating authentication data for the target applet in the applet and transmitting the authentication data to the target applet. The non-transitory computer-readable storage medium stores one or more computer programs including instructions that when executed by at least one processor, comprising processing circuitry, individually and/or collectively, of an electronic device, causes the electronic device to perform operations comprising determining whether to provide a function of the target applet to the applet by verifying the authentication data in the target applet.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example electronic device in a network environment, according to various embodiments;

FIG. 2 is a block diagram illustrating an example configuration of an electronic device including a secure element (SE) according to various embodiments;

FIG. 3 is a signal flow diagram illustrating an example operation of an electronic device that uses an allowlist to verify an applet according to the related art;

FIG. 4 is a diagram illustrating an SE according to various embodiments;

FIGS. 5 and 6 are signal flow diagrams illustrating example operations between an applet, an operating system (OS), and a target applet, according to various embodiments;

FIG. 7 is a flowchart illustrating an example operation of a target applet according to various embodiments;

FIG. 8 is a diagram illustrating an authentication key and a recovery key according to various embodiments;

FIG. 9 is a block diagram illustrating an example operation of an SE according to various embodiments; and

FIG. 10 is a flowchart illustrating an example operation of an electronic device according to various embodiments.

### DETAILED DESCRIPTION

Hereinafter, various example embodiments are described in greater detail with reference to the accompanying drawings. When describing the various embodiments with reference to the accompanying drawings, like reference numerals refer to like elements and any repeated description related thereto may not be repeated.

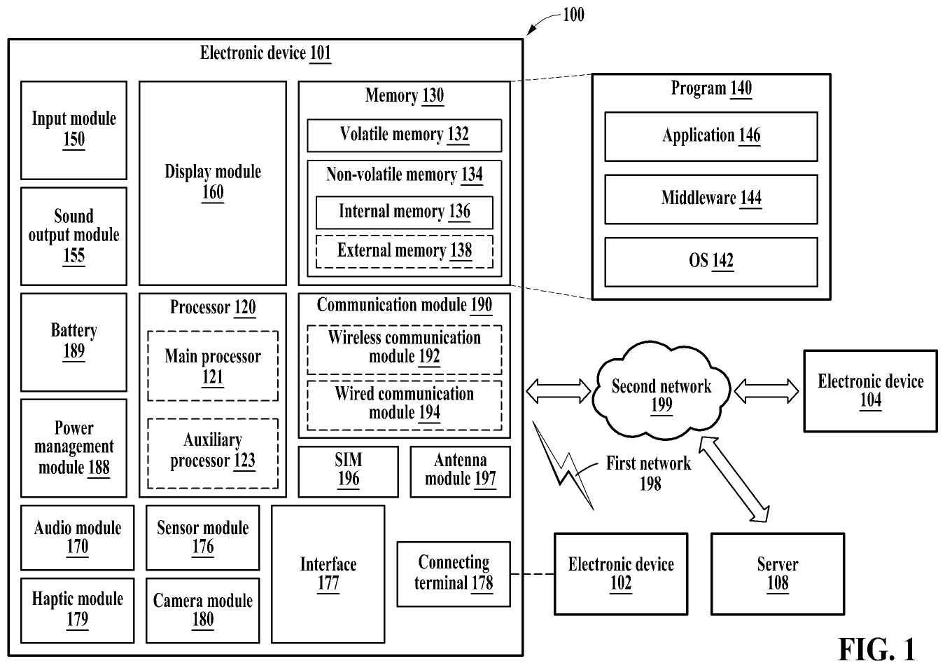

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network) or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one (e.g., the connecting terminal 178) of the components may be omitted from the electronic device 101, or one or more other components may be added to the electronic device 101. In various embodiments, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 connected to the processor 120 and may perform various types of data processing or operations. According to an embodiment, as at least a portion of data processing or a portion of an operation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of or in conjunction with the main processor 121. For example, when the electronic device 101 includes the main processor 121 and the auxiliary processor 123, the auxiliary processor 123 may be adapted to consume less power than the main processor 121 or to be specialized for a designated function. The auxiliary processor 123 may be implemented separately from the main processor 121 or as a portion of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is in an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specialized for artificial intelligence (AI) model processing. An AI model may be generated through machine learning. Such learning may be performed by, for example, the electronic device 101, in which an AI model is executed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from the outside (e.g., a user) of the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a portion of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to sense a touch or a pressure sensor adapted to measure the intensity of force incurred by the touch.

The audio module 170 may convert a sound into an electrical signal or vice versa. According to an embodiment, the audio module 170 may obtain the sound via the input module 150 or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a portion of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., a LAN or a wide area network (WAN)). These various types of communication modules may be implemented as a single component (e.g., a single chip) or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., an mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a portion of the antenna module 197.

According to various embodiments, the antenna module 197 may form a mmWave antenna module. According to an embodiment, the mmWave antenna module may include a PCB, an RFIC disposed on a first surface (e.g., a bottom surface) of the PCB, or adjacent to the first surface and capable of supporting a designated high-frequency band (e.g., the mmWave band), and a plurality of antennas (e.g., array antennas) disposed on a second surface (e.g., a top or a side surface) of the PCB, or adjacent to the second surface and capable of transmitting or receiving signals of the designated high-frequency band.

At least some of the components described above may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment, all or some of operations to be executed at the electronic device 101 may be executed at one or more external electronic devices (e.g., the external devices 102 and 104, or the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer a result of the performance to the electronic device 101. The electronic device 101 may provide the result, with or without further processing the result, as at least part of a response to the request. To that end, cloud computing, distributed computing, mobile edge computing (MEC), or client-server computing technology may be used, for example. The electronic device 101 may provide ultra low-latency services using, e.g., distributed computing or MEC. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic device may include, for example, a portable communication device (e.g., a smartphone), a computer device, a portable multimedia device, a portable medical device, a camera, a wearable device, a home appliance device, or the like. According to an embodiment of the present disclosure, the electronic device is not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., by wire), wirelessly, or via a third component.

As used in connection with various embodiments of the present disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device and may not include a signal (e.g., an electromagnetic wave), but this term does not differentiate between where data is semi-permanently stored in the storage medium and where the data is temporarily stored in the storage medium.

According to an embodiment, a method according to various embodiments of the present disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

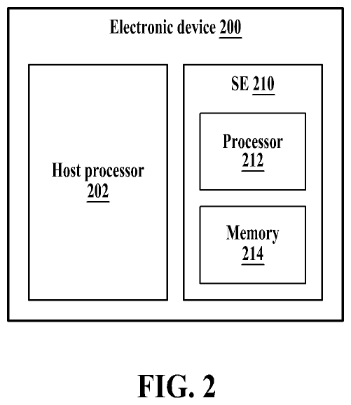

FIG. 2 is a block diagram illustrating an example configuration of an electronic device including a secure element (SE) according to various embodiments.

According to an embodiment, an electronic device 200 (e.g., the electronic device 101 of FIG. 1) may include at least one host processor (e.g., including processing circuitry) 202 (e.g., the processor 120 of FIG. 1) and a secure element (SE) (e.g., including various circuitry) 210. The SE 210 may include at least one processor (e.g., including processing circuitry) 212 and memory 214. The SE 210 may be electrically connected to the at least one host processor 202 and may transmit and receive data and/or a signal to and from the at least one host processor 202. The at least one host processor 202 may include an AP. The at least one host processor 202 may execute an application capable of communicating with the SE 210. The at least one host processor 202 may communicate with the SE 210 via the application.

According to an embodiment, the electronic device 200 may include various computing devices including the host processor 202 and the SE 210, such as a mobile phone, a smartphone, a tablet personal computer (PC), an e-book device, a laptop, a PC, a desktop, a workstation, or a server, various wearable devices such as a smart watch, smart eyeglasses, or a head-mounted display (HMD), various home appliances such as a smart speaker, a smart television (TV), or a smart refrigerator, and other devices such as a smart car, a smart kiosk, an Internet of things (IoT) device, a walking assist device (WAD), a drone, a robot, etc.

According to an embodiment, the SE 210 may include an embedded SE (eSE). However, this is an example, and the disclosure is not limited thereto. The SE 210 may include a chip designed to protect against unauthorized access so as to securely store data, securely process data, and securely communicate with an external electronic device (not shown). The at least one processor 212 within the SE 210 may include various processing circuitry and store confidential data and/or cryptographic data in the memory 214 and execute restricted applications (e.g., applets). For example, the at least one processor 212 may execute payment applets that require a high level of security and provide a reliable user interface capable of securely transmitting an electronic signature or personal information. The description provided above with reference to the processor 120 applies equally here to the processor 212.

According to an embodiment, the at least one processor 212 may store applets (e.g., installation data and/or execution data) directly in the memory 214 and filter access to the applets. The at least one processor 212 may store data (e.g., user data) generated through execution of the applets in the memory 214 and safely maintain the user data.

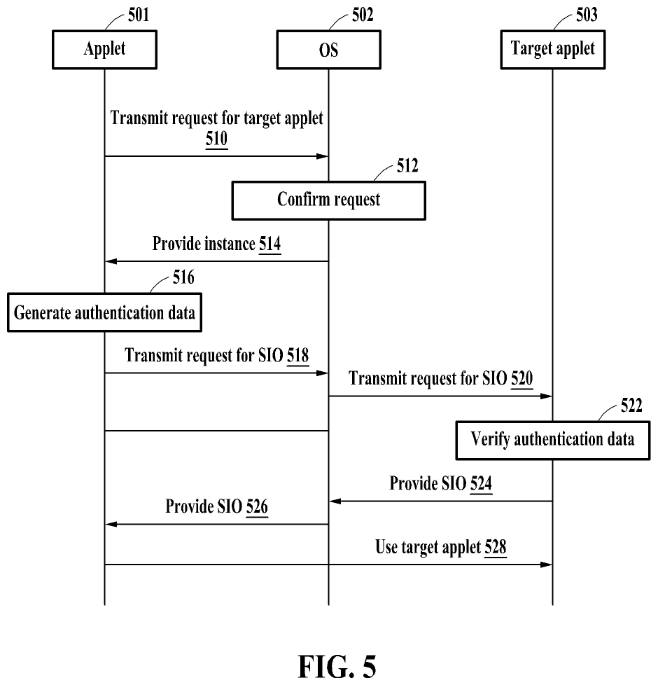

According to an embodiment, the applets executed by the at least one processor 212 may provide various security services. For example, applets may provide services that require security, such as identification (ID), payment, a transportation card, and a digital key (e.g., a door lock, a car key, etc.). When the SE 210 is included in the electronic device 200, the SE 210 may execute applets by receiving a command from the at least one host processor 202. For example, the SE 210 may execute applets by receiving a command from an application and/or a framework that may communicate with the SE 210 executed by the at least one host processor 202. For example, the at least one host processor 202 may control the SE 210, and execution of applets may be triggered by the at least one host processor 202. According to an embodiment, when the SE 210 receives a command to use a predetermined applet providing a predetermined function and/or a predetermined service from the at least one host processor 202, the operations described below with reference to FIGS. 5 to 7 may be performed.

According to an embodiment, the SE 210 may be in a form that is not included in the electronic device 200. For example, the SE 210 may be in the form of a credit card, an ID card, a transportation card, an access card, and the like. In this case, the SE 210 may execute applets by receiving a command from a separate external electronic device (e.g., a reader, etc.). When the SE 210 receives the command to use the predetermined applet that provides the predetermined function and/or the predetermined service from the external electronic device, the operations described in greater detail below with reference to FIGS. 5, 6 and 7 may be performed.

According to an embodiment, some applets may provide a predetermined (e.g., specified) function or a predetermined service to other applets. For example, some applets may provide a predetermined function or a predetermined service to other applets, such as applet deletion, applet installation, key injection, and data storage. However, these functions or predetermined services are only examples, and embodiments are not limited thereto. Some of the applets described above may include applets registered as a Global Service of the GlobalPlatform specification. Some of these applets do not only provide functions or services that require a special authority but may also provide a function or a service that may be commonly required by multiple applets within the SE 210.

According to an embodiment, applets installed in the SE 210 may freely call and use a predetermined applet that provides a predetermined function or a predetermined service. An applet that desires to use a predetermined applet may obtain an instance by calling an application programming interface (API) with an application identifier (AID) of the predetermined applet or a name of a predetermined function or predetermined service. For example, in the GlobalPlatform specification, an applet may obtain an instance by calling the API with the AID or service name of the Global Service. The applet that obtains the instance may use the predetermined function or the predetermined service provided by the predetermined applet by calling the API.

For example, the Global Service of the GlobalPlatform specification may include predetermined applets that provide a predetermined function or a predetermined service to other applets, such as a secure channel and a cardholder verification method (CVM). For example, applets installed in the SE 210 may use necessary functions or services by calling the secure channel and/or the CVM without having to directly implement the functions or services of the secure channel and/or the CVM.

Conventionally, there was no method of restricting an applet from using a predetermined applet that provides a predetermined function and/or a predetermined service. Therefore, when a predetermined applet is a critical applet that may perform a special operation (e.g., applet deletion, applet installation, key injection, and data storage, etc.) within the SE 210, issues may occur when any applet or a predetermined applet is called and used.

Therefore, there may be a method of using an allowlist to allow access only to some applets. Hereinafter, a method of using an allowlist to allow access only to some applets to a predetermined applet is described.

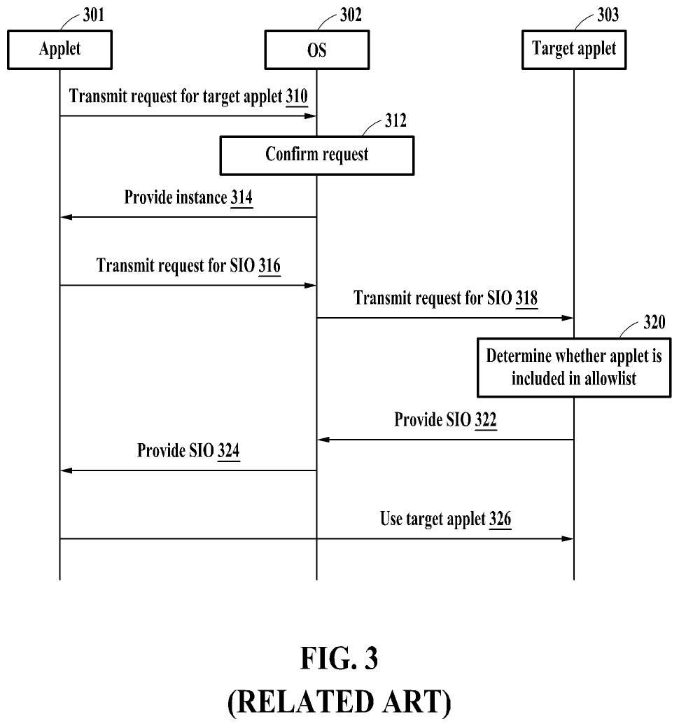

FIG. 3 is a signal flow diagram illustrating an example operation of an electronic device that uses an allowlist to verify an applet according to the related art.

FIG. 3 illustrates an applet 301, an operating system (OS) 302, and a target applet 303.

According to an embodiment, the applet 301 may include a program designed to perform a predetermined function within an SE (e.g., the SE 210 of FIG. 2). An applet may include an AID as an identifier to distinguish the applet from other applets. According to an embodiment, the applet 301 may call the target applet 303. The applet 301 may use a predetermined function or a predetermined service provided by the target applet 303 by calling the target applet 303.

According to an embodiment, the OS 302 may be an OS of the SE. For example, the OS 302 may include a card OS. The OS 302 may manage a hardware resource of the SE and provide an execution environment for the applet 301 and/or the target applet 303. According to an embodiment, the OS 302 may include OPEN of the GlobalPlatform specification.

According to an embodiment, the target applet 303 may be an applet that provides a predetermined function or a predetermined service to another applet. The target applet 303 may be an applet that provides a common function or a predetermined service required by one or more applets within the SE. The target applet 303 may be an applet called by the applet 301 for the purpose of using a predetermined function and/or a predetermined service. According to an embodiment, the target applet 303 may include a global service of the GlobalPlatform specification.

Hereinafter, example operations between the applet 301, the OS 302, and the target applet 303 for use of the target applet 303 are described.

In the following example embodiments, operations may be performed sequentially but not necessarily. For example, the order of the operations may change, and at least two of the operations may be performed in parallel. Operations 310 to 326 may be performed by at least one component (e.g., the processor 212 of FIG. 2) of an electronic device (e.g., the electronic device 101 of FIG. 1 and the electronic device 200 of FIG. 2). For example, instructions stored in memory (e.g., the memory 214 of FIG. 2) may be executed by at least one processor, and the instructions may cause the electronic device to perform the following operations 310 to 326.

In operation 310, the applet 301 may transmit a request for the target applet 303 to the OS 302.

According to an embodiment, the target applet 303 may be an applet that provides a predetermined function and/or a predetermined service to be used by the applet 301.

According to an embodiment, the applet 301 may call the target applet 303. The applet 301 may call the target applet 303 with an AID and/or name of the target applet 303.

According to an embodiment, the applet 301 may call the target applet 303 using getservice( ) of the GlobalPlatform specification.

In operation 312, the OS 302 may confirm the request from the applet 301.

According to an embodiment, the OS 302 may confirm the request from the applet 301 based on the AID and/or name of the target applet 303. The OS 302 may confirm the request from the applet 301 by confirming the AID and/or name of the target applet 303 in a registry.

For example, the OS may confirm the request from the applet 301 using a global registry of the Globalplatform specification.

In operation 314, the OS 302 may provide an instance to the applet 301. The OS 302 may provide an instance to the applet 301 when the AID and/or name of the target applet 303 is confirmed in the registry.

According to an embodiment, the OS 302 may provide an instance to the applet 301 by confirming the request from the applet 301. The OS 302 may provide the applet 301 with a new instance generated by the applet 301 and an existing instance.

In operation 316, the applet 301 may transmit a request for an SIO to the OS 302.

According to an embodiment, the SIO may be an interface object that an applet (e.g., the target applet 303) may provide to other applets. Multiple applets may interact with one another by sharing the SIO. For example, by sharing the SIO, the applet 301 may use a predetermined function and/or a predetermined service provided by the target applet 301.

According to an embodiment, the applet 301 may transmit a request for the SIO using getServiceinterface( ) of the GlobalPlatform specification.

In operation 318, the OS 302 may transmit a request for the SIO to the target applet 303.

According to an embodiment, the OS 302 that receives the request for the SIO from the applet 301 may transmit the request to the target applet 303.

In operation 320, the target applet 303 may determine whether the applet 301 is included in an allowlist.

According to an embodiment, the allowlist may be a list including AIDs of applets that may use a predetermined function and/or a predetermined service of the target applet 303.

According to an embodiment, the target applet 303 may determine whether the AID of the applet 301 is included in the allowlist. The target applet 303 may provide the SIO when the AID of the applet 301 is included in the allowlist. The target applet 303 may not provide the SIO when the AID of the applet 301 is not included in the allowlist. Herein, it is assumed that the AID of the applet 301 is included in the allowlist.

In operation 322, the target applet 303 may provide the SIO to the OS 302.

In operation 324, the OS 302 may provide the SIO to the applet 301.

According to an embodiment, the target applet 303 and the applet 301 may share the SIO.

In operation 326, the applet 301 may use the target applet 303. The applet 301 may use a predetermined function and/or a predetermined service of the target applet 303. The applet 301 may use the allowlist to allow the target applet 303 to be used only for a desired applet 301.

However, according to an embodiment, there may be a case in which the allowlist is bypassed. An AID may be information entered when an applet is installed and may be unique information of an applet that may not be duplicated among applets. Accordingly, when a designer generates an allowlist with the intention of allowing a first applet to use the target applet 303, but a second applet is installed first, rather than the first applet, and the second applet preempts an AID included in an allowlist, the allowlist may be bypassed.

According to an embodiment, when an SIO is shared due to bypass of the allowlist and the second applet uses a predetermined function and/or service requiring authentication of the target applet 303, repeated authentication failures may render an SE unusable.

Therefore, in order to prevent and/or reduce the issues described above, it may be required to block the sharing of an SIO. Hereinafter, a method of providing an SIO only to an applet authenticated using a cryptographic technique is described.

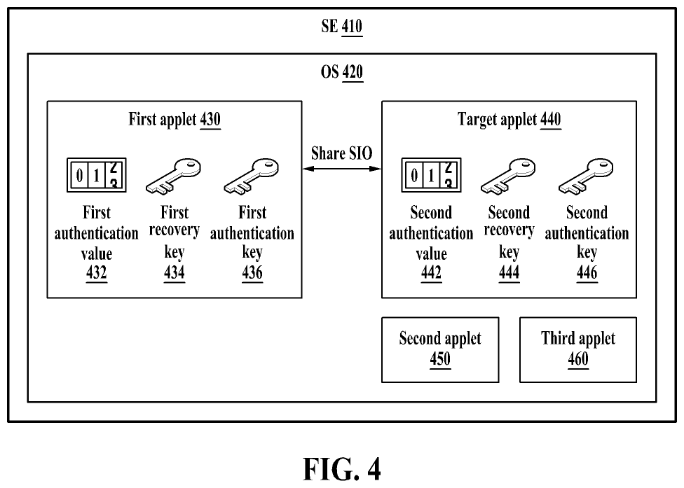

FIG. 4 is a diagram illustrating an SE according to various embodiments.

FIG. 4 illustrates various software components of an SE 410 (e.g., the SE 210 of FIG. 2). Since the SE 410, an applet, a target applet 440 (e.g., the target applet 303 of FIG. 3), and an OS 420 (e.g., the OS 302 of FIG. 3) are described above, the descriptions thereof may not be repeated.

In FIG. 4, it is assumed that the target applet 440 provides a predetermined function and/or a predetermined service only to a first applet 430 (e.g., the applet 301 of FIG. 3). For example, only the first applet 430 may use a predetermined function and/or a predetermined service of the target applet 440 by sharing an SIO with the target applet 440, and access of a second applet 450 and a third applet 460 to the target applet 440 may be restricted.

According to an embodiment, the first applet 430 and the target applet 440 may include the same recovery key and the same authentication key to allow only the first applet 430 to have access to the target applet 440. The second applet 450 and the third applet 460 may not include a recovery key and an authentication key. When the second applet 450 and the third applet 460 include a recovery key and an authentication key, the recovery key and the authentication key may be different from the recovery key and the authentication key of the target applet 440.

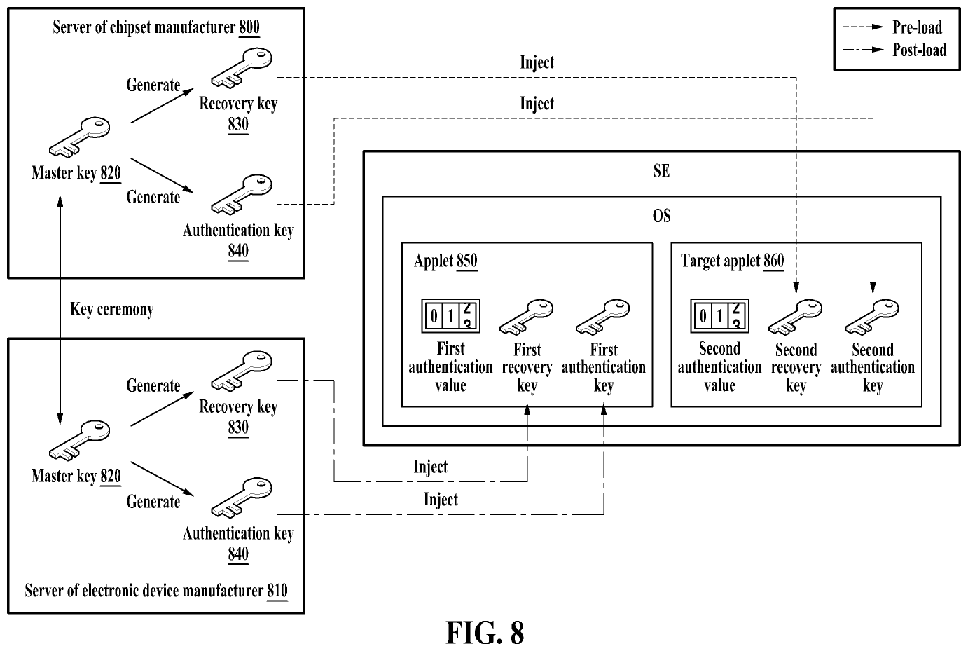

According to an embodiment, the first applet 430 may include a first recovery key 434 and a first authentication key 436. The first recovery key 434 and the first authentication key 436 may vary for each SE. For example, the first recovery key 434 and the first authentication key 436 may vary for each SE included in different electronic devices. The target applet 440 may include a second recovery key 444 and a second authentication key 446. The first recovery key 434 and the second recovery key 444, as symmetric keys, may be the same. The first authentication key 436 and the second authentication key 446, as symmetric keys, may be the same. The recovery keys and authentication keys of the first applet 430 and the target applet 440 may be generated based on the same master key. The generation of the recovery keys and authentication keys of the first applet 430 and the target applet 440 are described in greater detail below with reference to FIG. 8.

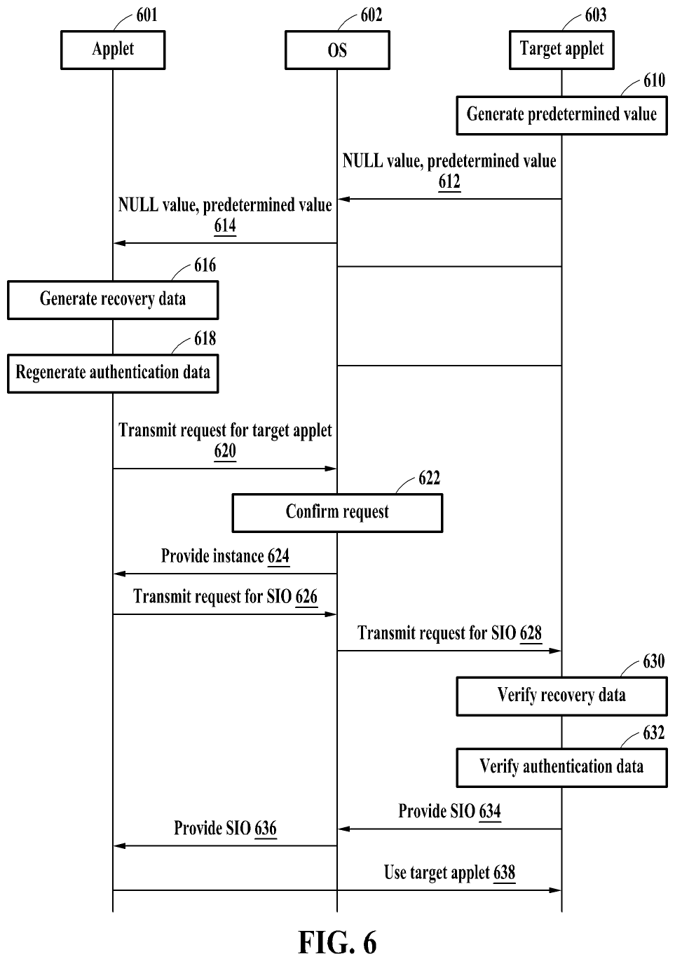

According to an embodiment, the first authentication key 436 may be used to generate authentication data for verification from the target applet 440. The second authentication key 446 may be used to verify the authentication data. The first recovery key 434 may be used to generate recovery data when the verification fails. The second recovery key 444 may be used to verify the recovery data. A cryptographic technique may be used to verify whether the first applet 430 may use the target applet 440, thereby increasing the level of security. The use of the first authentication key 436, the first recovery key 434, the second authentication key 446, and the second recovery key 444 is described below with reference to FIGS. 5 and 6.

According to an embodiment, the first applet 430 may include a first authentication value 432, and the target applet 440 may include a second authentication value 442. The initial values of the first authentication value 432 and the second authentication value 442 may be 0. The first authentication value 432 and the second authentication value 442 may be updated during the process of generating and verifying authentication data. The first authentication value 432 and the second authentication value 442 may be updated during the process of generating and verifying recovery data. Security may be improved by not reusing an authentication value that is already used.

Hereinafter, example operations between the first applet 430, the OS 420, and the target applet 440 are described in greater detail below with reference to FIGS. 5 and 6.

FIGS. 5 and 6 are signal flow diagrams illustrating example operations between an applet, an OS, and a target applet, according to various embodiments.

FIG. 5 illustrates an applet 501 (e.g., the applet 301 of FIG. 3 and the first applet 430 of FIG. 4), an OS 502 (e.g., the OS 302 of FIG. 3 and the OS 420 of FIG. 4), and a target applet 503 (e.g., the target applet 303 of FIG. 3 and the target applet 440 of FIG. 4). Since the applet 501, the OS 502, and the target applet 503 are described above, the detailed descriptions thereof may not be repeated here.

According to an embodiment, the applet 501 may include a first authentication value (e.g., the first authentication value 432 of FIG. 4), a first recovery key (e.g., the first recovery key 434 of FIG. 4), and a first authentication key (e.g., the first authentication key 436 of FIG. 4). The target applet 503 may include a second authentication value (e.g., the second authentication value 442 of FIG. 4), a second recovery key (e.g., the second recovery key 444 of FIG. 4), and a second authentication key (e.g., the second authentication key 446 of FIG. 4).

In the following example embodiments, operations may be performed sequentially but not necessarily. For example, the order of the operations may change, and at least two of the operations may be performed in parallel. Operations 510 to 528 may be performed by at least one component (e.g., the processor 212 of FIG. 2) of an electronic device (e.g., the electronic device 101 of FIG. 1 and the electronic device 200 of FIG. 2). For example, instructions stored in memory (e.g., the memory 214 of FIG. 2) may be executed by at least one processor, and the instructions may cause the electronic device to perform the following operations 510 to 528.

Since the descriptions of operations 310 to 314 of FIG. 3 may apply to operations 510 to 514, the descriptions of operations 510 to 514 may not be repeated here.

In operation 516, the applet 501 may generate authentication data.

According to an embodiment, the applet 501 may generate authentication data based on the first authentication value using the first authentication key. The applet 501 may update the first authentication value with the authentication data.

According to an embodiment, the applet 501 may generate a message authentication code (MAC) value for the first authentication value using the first authentication key. The applet 501 may determine the determined MAC value as the authentication data. The applet 501 may generate a MAC value using an algorithm such as hash-based MAC (HMAC) and advanced encryption standard-cipher MAC (AES-CMAC). However, this is only an example, and embodiments are not limited thereto. For example, it is apparent to those skilled in the art that a MAC value may be generated using a predetermined algorithm capable of generating a MAC value.

In operation 518, the applet 501 may transmit a request for an SIO to the OS 502.

According to an embodiment, the request for the SIO may include authentication data and an AID of the applet 501. According to an embodiment, the applet 501 may transmit a request for an SIO using getServiceinterface( ) of the GlobalPlatform specification.

In operation 520, the OS 502 may transmit a request for an SIO to the target applet 503. The OS 502 may transmit the request for the SIO received from the applet 501 to the target applet 503.

In operation 522, the target applet 503 may verify the authentication data. The target applet 503 may verify whether the applet 501 has the authority to use a predetermined function and/or a predetermined service provided by the target applet 503.

According to an embodiment, the target applet 503 may verify the authentication data included in the request for the SIO based on the second authentication value and the second authentication key. The target applet 503 may generate a MAC value for the second authentication value using the second authentication key. The target applet 503 may generate a MAC value using the same algorithm as the algorithm used to generate the authentication data. For example, the target applet 503 may generate a MAC value using an algorithm such as HMAC and AES-CMAC. However, this is only an example, and embodiments are not limited thereto.

According to an embodiment, the target applet 503 may compare, with the authentication data, the MAC value generated based on the second authentication value and the second authentication key. The target applet 503 may determine whether the MAC value and the authentication data are the same by comparing the MAC value with the authentication data. Referring to FIG. 5, it is assumed that the MAC value is the same as the authentication data. A case in which the MAC value is different from the authentication data is described in greater detail below with reference to FIG. 6.

According to an embodiment, the target applet 503 may further include an allowlist. The allowlist may be included in the target applet 503 in various ways. For example, the allowlist may be included in the target applet 503 over the air. For example, the allowlist may be included in the target applet 503 at the time of booting an SE (e.g., the SE 210 of FIG. 2 and the SE 410 of FIG. 4). However, this is an example, and the disclosure is not limited thereto.

According to an embodiment, when the target applet 503 includes the allowlist, the target applet 503 may additionally check whether an AID of the applet 501 included in the request for the SIO is included in the allowlist. In this case, the target applet 503 may perform operation 524 when the MAC value is the same as the authentication data and the AID of the applet 501 is included in the allowlist. The target applet 503 may perform additional verification using the allowlist as well as cryptographic verification based on the second authentication value and the second authentication key.

In operation 524, the target applet 503 may provide an SIO.

According to an embodiment, when the verification is successful, the target applet 503 may provide an SIO.

In operation 526, the OS 502 may provide an SIO to the applet 501. The OS 502 may transmit the SIO provided from the target applet 503 to the applet 501.

Since the descriptions of operations 322 and 324 of FIG. 3 may apply to operations 524 and 526, the descriptions of operations 524 and 526 may not be repeated.

By transmitting the SIO to the applet 501, the target applet 503 and the applet 501 may share the SIO.

In operation 528, the applet 501 may use the target applet 503. The applet 501 may use a predetermined function and/or a predetermined service provided by the target applet 503.

Hereinafter, an operation in which verification fails in operation 522 is described.

FIG. 6 is a signal flow diagram illustrating an applet 601 (e.g., the applet 301 of FIG. 3, the first applet 430 of FIG. 4, and the applet 501 of FIG. 5), an OS 602 (e.g., the OS 302 of FIG. 3, the OS 420 of FIG. 4, and the OS 502 of FIG. 5), and a target applet 603 (e.g. the target applet 303 of FIG. 3, the target applet 440 of FIG. 4, and the target applet 503 of FIG. 5). Since the applet 601, the OS 602, and the target applet 603 are described above, the detailed descriptions thereof may not be repeated here.

According to an embodiment, the applet 601 may include a first authentication value (e.g., the first authentication value 432 of FIG. 4), a first recovery key (e.g., the first recovery key 434 of FIG. 4), and a first authentication key (e.g., the first authentication key 436 of FIG. 4). The target applet 603 may include a second authentication value (e.g., the second authentication value 442 of FIG. 4), a second recovery key (e.g., the second recovery key 444 of FIG. 4), and a second authentication key (e.g., the second authentication key 446 of FIG. 4).

In the following embodiments, operations may be performed sequentially but not necessarily. For example, the order of the operations may change, and at least two of the operations may be performed in parallel. Operations 610 to 628 may be performed by at least one component (e.g., the processor 212 of FIG. 2) of an electronic device (e.g., the electronic device 101 of FIG. 1 and the electronic device 200 of FIG. 2). For example, instructions stored in memory (e.g., the memory 214 of FIG. 2) may be executed by at least one processor, and the instructions may cause the electronic device to perform the following operations 510 to 528.

When the verification fails in operation 522 of FIG. 5, the target applet 603 may perform operation 610.

In operation 610, the target applet 603 may generate a predetermined value. The target applet 603 may store the generated predetermined value. The predetermined value may include a random value, a value designated by the target applet 603, or a value generated by the target applet 603 through various algorithms.

In operation 612, the target applet 603 may transmit a NULL value and a predetermined value.

According to an embodiment, since the validation fails, the target applet 603 may respond to the request for the SIO with a NULL value rather than an SIO. According to an embodiment, the target applet 603 may use an identifier, such as a flag, to indicate that repair is needed for the applet 601.

In operation 614, the OS 602 may transmit a NULL value and a predetermined value to the applet 601. The OS 602 may transmit, to the applet 601, the NULL value and the predetermined value received from the target applet 603.

In operation 616, the applet 601 may generate recovery data.

According to an embodiment, when receiving a NULL value and/or a predetermined value in response to the transmission of authentication data, the applet 601 may generate recovery data. For example, when receiving the NULL value and/or the predetermined value in response to the transmission of authentication data, the applet 601 may determine that the synchronization between a first authentication value and a second authentication value is out of alignment and may perform recovery.

According to an embodiment, the applet 601 may generate recovery data based on the predetermined value using a first recovery key. For example, the applet 601 may generate a MAC value based on the predetermined value using the first recovery key.

In operation 618, the applet 601 may regenerate authentication data. For example, the applet 601 may regenerate a MAC value.

According to an embodiment, the applet 601 may regenerate the authentication data based on the predetermined value or the recovery data based on a first authentication key. The authentication data regenerated in operation 618 may be different from the authentication data generated in operation 516 of FIG. 5.

According to an embodiment, the applet 601 may update the first authentication value with the regenerated authentication data.

In operation 620, the applet 601 may transmit a request for the target applet 603.

In operation 622, the OS 602 may confirm the request.

In operation 624, the OS 602 may provide an instance to the applet 601.

Since the descriptions of operations 310 to 314 of FIG. 3 may apply to operations 620 to 624, the descriptions of operations 620 to 624 may not be repeated here.

In operation 626, the applet 601 may transmit a request for an SIO.

According to an embodiment, the request for the SIO may include an AID of the applet 601, regenerated authentication data, and recovery data.

In operation 628, the OS 602 may transmit the request for the SIO to the target applet 603. The OS 602 may transmit, to the target applet 603, the request for the SIO received from the applet 601.

In operation 630, the target applet 603 may verify the recovery data. The target applet 603 may determine whether to provide a predetermined function and/or a predetermined service of the target applet to the applet 601 through verification based on the recovery data.

According to an embodiment, when the request for the SIO includes the recovery data, the target applet 603 may perform verification of the recovery data. The target applet 603 may verify the recovery data based on a second recovery key and the predetermined value stored in operation 610. The target applet 603 may generate comparison data using the same way that the applet 601 generates the recovery data based on the second recovery key and the predetermined value. The target applet 603 may compare the comparison data with the recovery data included in the request for the SIO to determine whether the comparison data is the same as the recovery data. When the comparison data is the same as the recovery data, the target applet may perform operation 632.

According to an embodiment, when the verification of the recovery data fails in operation 630, the target applet 603 may terminate the operation without providing an SIO to the applet 601. When the verification of the recovery data fails in operation 630, the target applet 603 may perform operation 610 again. The target applet 603 may perform operations 610 to 630 repeatedly for a threshold number of times. When the threshold number of times is reached but the verification of the recovery data fails in operation 630, the target applet 603 may terminate the operation without providing an SIO to the applet 601.

Hereinafter, for ease of description, it is assumed that the comparison data is the same as the recovery data.

According to an embodiment, when the comparison data is the same as the recovery data, the target applet 603 may update the second authentication value to a predetermined value or the recovery data. When the authentication data is regenerated based on a predetermined value, the second authentication value may be updated to the predetermined value. When the authentication data is regenerated based on the recovery data, the second authentication value may be updated with the recovery data.

In operation 632, the target applet 603 may verify the regenerated authentication data.

According to an embodiment, the target applet 603 may verify the regenerated authentication data based on the updated second authentication value and the second authentication key. The target applet 603 may generate a MAC value for the second authentication value updated with the second authentication key. The target applet 603 may generate a MAC value using the same algorithm as the algorithm used to generate the authentication data. For example, the target applet 603 may generate a MAC value using an algorithm such as HMAC and AES-CMAC. However, this is only an example, and embodiments are not limited thereto. When the verification is successful, the target applet may perform operation 634.

According to an embodiment, when the verification of the authentication data fails in operation 632, the target applet 603 may perform operation 610 again. According to an embodiment, when the number of times the verification fails exceeds a threshold, the target applet 603 may terminate the operation of FIG. 6 without performing operation 610. A threshold may be the maximum number of retries for recovery. For example, when the number of times the verification fails exceeds a threshold (e.g., 5 times), the target applet 603 may no longer generate a predetermined value and terminate the operation.

In operation 634, the target applet 603 may provide an SIO.

In operation 636, the OS 602 may provide an SIO to the applet 601.

In operation 638, the applet 601 may use the target applet.

Since the descriptions of operations 322 to 326 of FIG. 3 and operations 524 to 528 of FIG. 5 may apply to operations 634 to 638, the descriptions of operations 634 to 638 may not be repeated here.

Hereinafter, the operations of the present disclosure are described based on the target applet 603 that receives a request for an SIO.

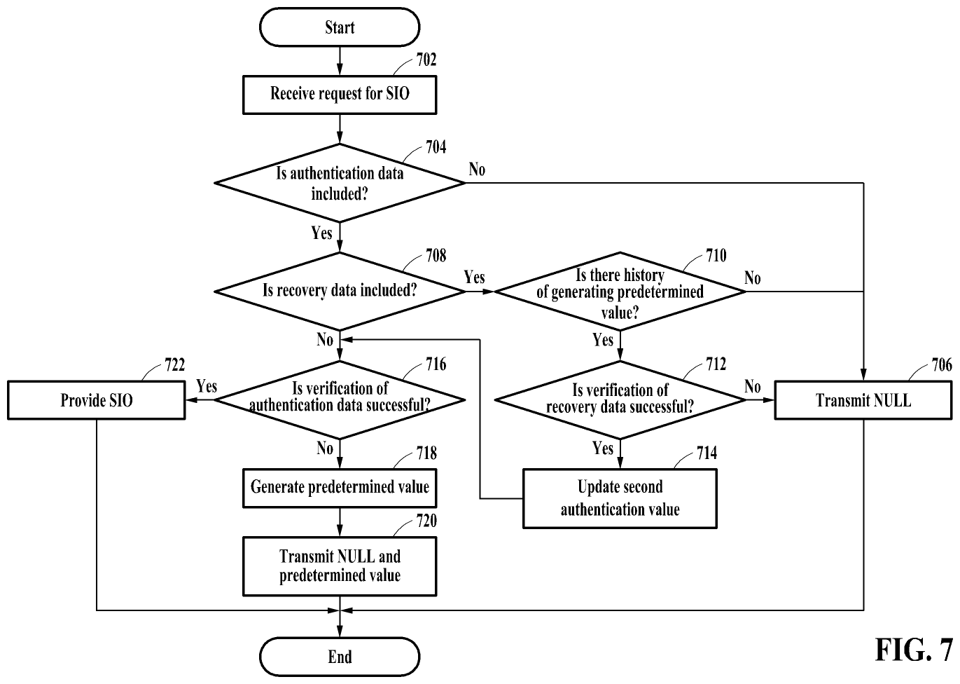

FIG. 7 is a flowchart illustrating an example operation of a target applet according to various embodiments.

In the following example embodiments, operations may be performed sequentially but not necessarily. For example, the order of the operations may change, and at least two of the operations may be performed in parallel. Operations 610 to 628 may be performed by at least one component (e.g., the processor 212 of FIG. 2) of an electronic device (e.g., the electronic device 101 of FIG. 1 and the electronic device 200 of FIG. 2). For example, instructions stored in memory (e.g., the memory 214 of FIG. 2) may be executed by at least one processor, and the instructions may cause the electronic device to perform the following operations 510 to 528.

In operation 702, a target applet (e.g., the target applet 303 of FIG. 3, the target applet 440 of FIG. 4, the target applet 503 of FIG. 5, and the target applet 603 of FIG. 6) may receive a request for an SIO.

In operation 704, the target applet may determine whether the request for the SIO includes authentication data. When the authentication data is included, the target applet may perform operation 708. When no authentication data is included, the target applet may perform operation 706.

In operation 706, the target applet may transmit a NULL value. The target applet may transmit the NULL value to an OS (e.g., the OS 302 of FIG. 3, the OS 420 of FIG. 4, the OS 502 of FIG. 5, and the OS 602 of FIG. 6).

In operation 708, the target applet may determine whether the request for the SIO includes recovery data. When the recovery data is included, the target applet may perform operation 710. When no recovery data is included, the target applet may perform operation 716.

In operation 710, the target applet may determine whether there is a history of generating a predetermined value. The predetermined value may include a random value, a value designated by the target applet 603, or a value generated by the target applet 603 through various algorithms. The target applet may generate a predetermined value and store the predetermined value in an output buffer when verification of the authentication data fails previously. The target applet may determine whether the predetermined value is generated by determining whether the stored predetermined value exists. When the target applet has a history of generating the predetermined value, the target applet may perform operation 712. When there is no history of generating the predetermined value, the target applet may perform operation 706.

In operation 712, the target applet may determine whether verification of the recovery data is successful. Since the description of the verification of the recovery data is provided in operation 630 of FIG. 6, the detailed description thereof may not be repeated here. When the verification of the recovery data is successful, the target applet may perform operation 714. When the verification of the recovery data fails, the target applet may perform operation 706.

In operation 714, the target applet may update a second authentication value (e.g., the second authentication value 442 of FIG. 4). The target applet may update the second authentication value to the predetermined value or random data. The target applet may update the second authentication value to the predetermined value when regenerated authentication data is generated based on the predetermined value. The target applet may update the second authentication value to the random data when regenerated authentication data is generated based on the random data.

In operation 716, the electronic device may perform verification of the authentication data and determine whether the verification of the authentication data is successful. When it is determined in operation 708 that the request for the SIO does not include the recovery data, the authentication data to be verified in operation 716 may be data generated based on a first authentication value (e.g., the first authentication value 432 of FIG. 4). When it is determined that the request for the SIO in operation 708 includes the recovery data, the authentication data to be verified in operation 716 may be data generated based on the predetermined value or the random data. Since the verification of the authentication data is described in operation 522 of FIG. 5 and operation 632 of FIG. 6, the detailed description thereof may not be repeated here. When the verification of the authentication data is successful, the target applet may perform operation 722. When the verification of the authentication data fails, the target applet may perform operation 718.

In operation 718, the target applet may generate a predetermined value. The predetermined value may include a random value, a value designated by the target applet 603, or a value generated by the target applet 603 through various algorithms.

In operation 720, the target applet may transmit a NULL value and the predetermined value to the OS.

In operation 722, the target applet may provide an SIO. The target applet may transmit the SIO to the OS.

Hereinafter, a method of provisioning a recovery key and an authentication key to an applet (e.g., the applet 301 of FIG. 3, the first applet 430 of FIG. 4, the applet 501 of FIG. 5, and the applet 601 of FIG. 6) and a target applet (e.g., the target applet 303 of FIG. 3, the target applet 440 of FIG. 4, the target applet 503 of FIG. 5, and the target applet 603 of FIG. 6) to perform the operations described above with reference to FIGS. 5, 6 and 7 is described.

FIG. 8 is a diagram illustrating an example authentication key and recovery key according to various embodiments.

According to an embodiment, a first recovery key (e.g., the first recovery key 434 of FIG. 4) of an applet 850 (e.g., the applet 301 of FIG. 3, the first applet 430 of FIG. 4, the applet 501 of FIG. 5, and the applet 601 of FIG. 6) and a second recovery key (e.g., the second recovery key 444 of FIG. 4) of a target applet 860 (e.g., the target applet 303 of FIG. 3, the target applet 440 of FIG. 4, the target applet 503 of FIG. 5, and the target applet 603 of FIG. 6) may be symmetric keys. A first authentication key (e.g., the first authentication key 436 of FIG. 4) of the applet 850 and a second authentication key (e.g., the second authentication key 446 of FIG. 4) of the target applet 860 may be symmetric keys. The first recovery key and the second recovery key, as symmetric keys, may be the same. The first authentication key and the second authentication key, as symmetric keys, may be the same. The first recovery key and the second recovery key may be the same as a recovery key 830, and the first authentication key and the second authentication key may be the same as an authentication key 840.

According to an embodiment, the recovery key 830 and the authentication key 840 may be injected when the applet 850 and/or the target applet 860 are installed in an SE (e.g., the SE 210 of FIG. 2 and the SE 410 of FIG. 4). The recovery key 830 and the authentication key 840 may be injected when the applet 850 and/or target applet 860 are installed during a chipset process before the SE is delivered to the manufacturer of an electronic device (e.g., pre-loaded). The recovery key 830 and the authentication key 840 may be injected when the applet 850 and/or the target applet 860 are installed after the SE is delivered to the manufacturer of the electronic device or when a user actually uses the applet 850 and/or the target applet 860 (e.g., post-load). According to an embodiment, the recovery key 830 and the authentication key 840 may be injected into the applet 850 and/or the target applet 860 through an update of the applet 850 and/or the target applet 860. However, this is only an example, and the disclosure is not limited thereto. For example, the recovery key 830 and the authentication key 840 may be injected at various points in time other than the example described above.

However, in order for the applet and the target applet to share the recovery key 830 and the authentication key 840 as described herein, regardless of a point in time at which a key is injected, entities (e.g., a server of an SE manufacturer (e.g., a server 800 of a chipset manufacturer) and a server 810 of an electronic device manufacturer) installing the applet 850 and/or the target applet 860 may need to be able to generate the recovery key 830 and the authentication key 840. To this end, the server 800 of the chipset manufacturer and the server 810 of the electronic device manufacturer may share the same master key and generate the recovery key 830 and the authentication key 840 based on the same key derivation function.

According to an embodiment, the server 800 of the chipset manufacturer and the server 810 of the electronic device manufacturer may share a master key 820 through a key ceremony. The server 800 of the chipset manufacturer and the server 810 of the electronic device manufacturer may generate the recovery key 830 and the authentication key 840 based on the master key 820. A key derivation function for deriving the recovery key 830 from the master key 820 may be different from a key derivation function for deriving the authentication key 840 from the master key 820. The server 800 of the chipset manufacturer and the server 810 of the electronic device manufacturer may generate the recovery key 830 using the same key derivation function. The server 800 of the chipset manufacturer and the server 810 of the electronic device manufacturer may generate the authentication key 840 using the same key derivation function.

According to an embodiment, the recovery key 830 and the authentication key 840 may be generated from a single master key (e.g., the master key 820). However, by performing the key ceremony twice, the recovery key 830 may be generated based on a first master key shared between the server 800 of the chipset manufacturer and the server 810 of the electronic device manufacturer, and the authentication key 840 may be generated based on a second master key.

According to an embodiment, it is assumed that injection of the recovery key 830 and the authentication key 840 to the target applet 860 is performed during the chipset process (e.g., pre-load) and that injection of the recovery key 830 and the authentication key 840 to the applet 850 is performed after an SE is delivered to the manufacturer of the electronic device. Although the injection of the recovery key 830 and the authentication key 840 into the target applet 860 and the applet 850 are performed at different times, the server 800 of the chipset manufacturer and the server 810 of the electronic device manufacturer may share the same master key 820 through the key ceremony and generate a recovery key and an authentication key using the same key derivation function. Therefore, the applet 850 and the target applet 860 may include the first recovery key and the second recovery key, respectively, wherein the first recovery key and the second recovery key are in a symmetric key relationship. The applet 850 and the target applet 860 may include the first authentication key and the second authentication key, respectively, wherein the first authentication key and the second authentication key are in a symmetric key relationship.

According to an embodiment, the server 810 of the electronic device manufacturer and a server of a service provider (e.g., a credit card service provider, a transportation card service provider, an access card service provider, etc.) may share a master key through a key ceremony. The server of the electronic device manufacturer may provide a target applet. The server of the service provider may provide an applet. Since a method by which the server 810 of the electronic device manufacturer and the server of the service provider generate a recovery key and an authentication key and inject the recovery key and the authentication key into the applet and the target applet is described above, a detailed description thereof may not be repeated here.

Hereinafter, a case in which an SE is not included in an electronic device is described.

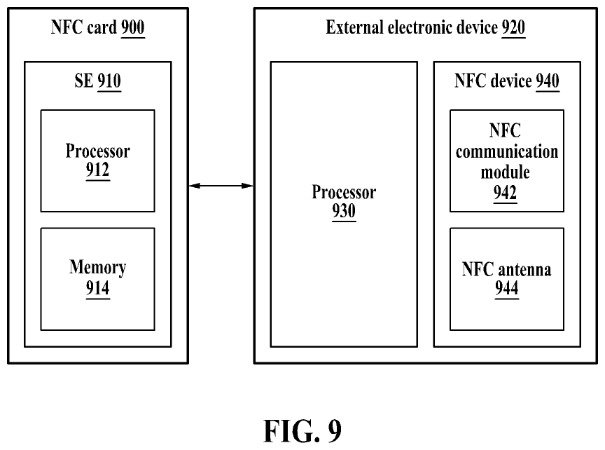

FIG. 9 is a diagram illustrating an example operation of an SE according to various embodiments.

Referring to FIG. 9, a near field communication (NFC) card 900 is illustrated as an example of a case in which an SE 910 (e.g., the SE 210 of FIG. 2 and the SE 410 of FIG. 4) is not included in an electronic device (e.g., the electronic device 101 of FIG. 1 and the electronic device 200 of FIG. 2). However, this is only an example, and disclosure is not limited thereto. For example, it is apparent to those skilled in the art that the following description may also apply to a case in which the SE 910 is not included in the electronic device.

According to an embodiment, the NFC card 900 may include the SE 910. The SE 910 may include at least one processor (e.g., including processing circuitry) 912 (e.g., the processor 212 of FIG. 2) and memory 914 (e.g., the memory 214 of FIG. 2).

According to an embodiment, an external electronic device 920 may be a device that interacts with the NFC card 900. For example, the external electronic device 920 may be a reader for the NFC card 900. The external electronic device 920 may include at least one processor (e.g., including processing circuitry) 930 (e.g., the processor 120 of FIG. 1 and the host processor 202 of FIG. 2) and an NFC device (e.g., including circuitry) 940. The at least one processor 930 may control the operation of the external electronic device 920 and control the NFC device 940.

According to an embodiment, the NFC device 940 may include an NFC communication module (e.g., including communication circuitry) 942 and an NFC antenna 944. The NFC device 940 may communicate with the NFC card 900. The NFC communication module 942 may include a communication circuit for performing NFC with the NFC card 900. The NFC communication module 942 may wirelessly communicate with the NFC card 900 through the NFC antenna 944.

According to an embodiment, communication may be performed when the external electronic device 920 and the NFC card 900 are adjacent to each other. When the NFC device 940 and the NFC card 900 are disposed adjacent to each other, the NFC device 940 may generate a magnetic field, and a current induced by the generation of the magnetic field may supply power to the NFC card 900, thereby allowing data transmission between the NFC device 940 and the NFC card 900.

According to an embodiment, when the NFC device 940 and the NFC card 900 transmit and/or receive data, the operations of FIGS. 5, 6 and 7 may be performed in the SE 910 of the NFC card 900. For example, data transmission between the NFC device 940 and the NFC card 900 may act as a trigger to cause the SE 910 to perform the operations of FIGS. 5, 6 and 7. For example, supplying power to the NFC card 900 may act as a trigger to cause the SE 910 to perform the operations of FIGS. 5, 6 and 7. However, this is only an example, and embodiments are not limited thereto.

According to an embodiment, when the operation of SE 910 is triggered, instructions stored in the memory 914 may be executed by the at least one processor 912. When the at least one processor 912 individually and/or collectively executes instructions, the instructions may cause the SE 910 to transmit a request for a target applet (e.g., the target applet 303 of FIG. 3, the target applet 440 of FIG. 4, the target applet 503 of FIG. 5, the target applet 603 of FIG. 6, and the target applet 860 of FIG. 8) to be used by an applet (e.g., the applet 301 of FIG. 3, the first applet 430 of FIG. 4, the applet 501 of FIG. 5, the applet 601 of FIG. 6, and the applet 850 of FIG. 8) to an OS (e.g., the OS 302 of FIG. 3, the OS 420 of FIG. 4, the OS 502 of FIG. 5, and the OS 602 of FIG. 6) of the SE 910. When the at least one processor 912 individually and/or collectively executes instructions, the instructions may cause the SE 910 to provide an instance to the applet in response to the request for the target applet. When the at least one processor 912 individually and/or collectively executes instructions, the instructions may cause the SE 910 to generate authentication data for the target applet from the applet and transmit the authentication data to the target applet. When the at least one processor 912 individually and/or collectively executes instructions, the instructions may cause the SE 910 to verify the authentication data in the target applet to determine whether to provide a function of the target applet to the applet.

Since the operations of the SE 910 described above are described in detail with reference to FIGS. 1, 2, 3, 4, 5, 6, 7 and 8, the detailed descriptions thereof may not be repeated here.

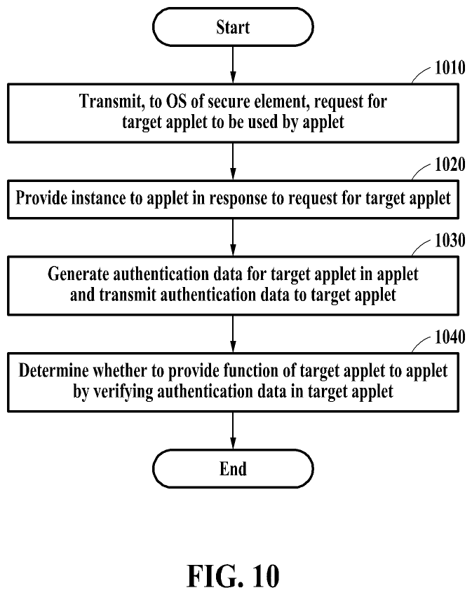

FIG. 10 is a flowchart illustrating an example operation of an electronic device according to various embodiments.

In the following embodiments, operations may be performed sequentially but not necessarily. For example, the order of the operations may change, and at least two of the operations may be performed in parallel. Operations 1010 to 1040 may be performed by at least one component of an electronic device (e.g., the electronic device 101 of FIG. 1 and the electronic device 200 of FIG. 2). For example, instructions stored in memory (e.g., the memory 214 of FIG. 2 and the memory 914 of FIG. 9) may be executed by at least one processor (e.g., the processor 212 of FIG. 2 and the processor 912 of FIG. 9), and the instructions may cause the electronic device to perform operations 1010 to 1040 below.

In operation 1010, the electronic device may transmit, to an OS (e.g., the OS 302 of FIG. 3, the OS 420 of FIG. 4, the OS 502 of FIG. 5, and the OS 602 of FIG. 6) of an SE (e.g., the SE 210 of FIG. 2, the SE 410 of FIG. 4, and the SE 910 of FIG. 9), a request for a target applet (e.g., the target applet 303 of FIG. 3, the target applet 440 of FIG. 4, the target applet 503 of FIG. 5, the target applet 603 of FIG. 6, and the target applet 860 of FIG. 8) to be used by an applet (e.g., the applet 301 of FIG. 3, the first applet 430 of FIG. 4, the applet 501 of FIG. 5, the applet 601 of FIG. 6, and the applet 850 of FIG. 8).

In operation 1020, the electronic device may provide an instance to the applet in response to the request for the target applet.

In operation 1030, the electronic device may generate authentication data for the target applet in the applet and transmit the authentication data to the target applet.

In operation 1040, the electronic device may determine whether to provide a function of the target applet by verifying the authentication data in the target applet.

Since operations 1010 to 1040 are described with reference to FIGS. 1, 2, 3, 4, 5, 6, 7, 8 and 9, the detailed descriptions thereof may not be repeated here.

According to an embodiment, the electronic device may include at least one host processor (e.g., the processor 120 of FIG. 1 and the host processor 202 of FIG. 2). The electronic device may include an SE electrically connected to at least one host processor. The SE may include memory (e.g., the memory 214 of FIG. 2 and the memory 914 of FIG. 9) storing instructions. The SE may include at least one processor (e.g., the processor 212 of FIG. 2 and the processor 912 of FIG. 9) that executes the instructions. When the at least one processor individually and/or collectively executes the instructions, the instructions may cause the electronic device to transmit, to an OS of the SE, a request for a target applet to be used by an applet. When the at least one processor individually and/or collectively executes the instructions, the instructions may cause the electronic device to provide an instance to the applet in response to the request for the target applet. When the at least one processor individually and/or collectively executes instructions, the instructions may cause the electronic device to generate authentication data for the target applet in the applet and transmit the authentication data to the target applet. When the at least one processor individually and/or collectively executes instructions, the instructions may cause the electronic device to determine whether to provide a function of the target applet to the applet by verifying the authentication data in the target applet.

According to an embodiment, when the at least one processor individually and/or collectively executes instructions, the instructions may cause the electronic device to generate, in the applet, authentication data based on a first authentication value (e.g., the first authentication value 432 of FIG. 4) using a first authentication key (e.g., the first authentication key 436 of FIG. 4). When the at least one processor individually and/or collectively executes instructions, the instructions may cause the electronic device to update the first authentication value with authentication data.

According to an embodiment, when the at least one processor individually and/or collectively executes instructions, the instructions may cause the electronic device to generate a MAC value for the first authentication value with a first authentication key. When the at least one processor individually and/or collectively executes instructions, the instructions may cause the electronic device to determine a MAC value as the authentication data.

According to an embodiment, the applet may include the first authentication key that is used to generate the authentication data. The applet may include a first recovery key (e.g., the first recovery key 434 of FIG. 4) that is used to generate recovery data when verification fails. The applet may include a first authentication value that is updated with the authentication data generated by the first authentication key.

According to an embodiment, the target applet may include a second authentication key (e.g., the second authentication key 446 of FIG. 4) for verifying the authentication data. The target applet may include a second recovery key (e.g., the second recovery key 444 of FIG. 4) for verifying the recovery data generated from the applet when verification fails. The target applet may include a second authentication value (e.g., the second authentication value 442 of FIG. 4) that is updated with the authentication data when the verification of the authentication data is successful.

According to an embodiment, when the at least one processor individually and/or collectively executes instructions, the instructions may cause the electronic device to verify the authentication data in the target applet based on the second authentication key and the second authentication value included in the target applet.

According to an embodiment, when the at least one processor individually and/or collectively executes instructions, the instructions may cause the electronic device to allow the target applet and the applet to share an SIO when verification is successful.

According to an embodiment, when the at least one processor individually and/or collectively executes instructions, the instructions may cause the electronic device to generate a predetermined value in the target applet and transmit the predetermined value to the applet when verification fails. When the at least one processor individually and/or collectively executes instructions, the instructions may cause the electronic device to generate recovery data based on the predetermined value using a first recovery key in the applet. When the at least one processor individually and/or collectively executes instructions, the instructions may cause the electronic device to regenerate authentication data from the predetermined value or the recovery data based on the first authentication key included in the applet. When the at least one processor individually and/or collectively executes the instructions, the instructions may cause the electronic device to transmit the regenerated authentication data and the recovery data to the target applet.

According to an embodiment, when the at least one processor individually and/or collectively executes instructions, the instructions may cause the electronic device to receive the regenerated authentication data and the recovery data from the target applet. When the at least one processor individually and/or collectively executes instructions, the instructions may cause the electronic device to determine whether to provide a function of the target applet to the applet through verification based on the recovery data in the target applet.

According to an embodiment, when the at least one processor individually and/or collectively executes instructions, the instructions may cause the electronic device to verify the recovery data based on the second recovery key and the predetermined value that verify the recovery data in the target applet. When the at least one processor individually and/or collectively executes instructions, the instructions may cause the electronic device to update the second authentication value included in the target applet to the predetermined value or the recovery data, when the verification of the recovery data is successful. When the at least one processor individually and/or collectively executes instructions, the instructions may cause the electronic device to determine whether to provide the function of the target applet to the applet by verifying the regenerated authentication data with the second authentication key and the updated second authentication value.

According to an embodiment, an SE includes memory storing instructions. The SE may include at least one processor that executes instructions. When the at least one processor individually and/or collectively executes instructions, the instructions may cause an electronic device to transmit, to an OS of the SE, a request for a target applet to be used by an applet. When the at least one processor individually and/or collectively executes instructions, the instructions may cause the electronic device to provide an instance to the applet in response to the request for the target applet. When the at least one processor individually and/or collectively executes instructions, the instructions may cause the electronic device to generate authentication data for the target applet in the applet and transmit the authentication data to the target applet. When the at least one processor individually and/or collectively executes instructions, the instructions may cause the electronic device to determine whether to provide a function of the target applet to the applet by verifying the authentication data in the target applet.

According to an embodiment, an operating method of an electronic device may include transmitting, to an OS of an SE, a request for a target applet to be used by an applet. The operating method may include providing an instance to the applet in response to the request for the target applet. The operating method may include generating authentication data for the target applet and transmitting the authentication data to the target applet. The operating method may include determining whether to provide a function of the target applet to the applet by verifying the authentication data in the target applet.

According to an embodiment, the transmitting of the authentication data to the target applet may include generating the authentication data based on a first authentication value using a first authentication key in the applet. The transmitting of the authentication data to the target applet may include updating the first authentication value with the authentication data.

According to an embodiment the target applet may include a second authentication key for verifying the authentication data. The target applet may include a second recovery key for verifying recovery data generated from the applet when verification fails. The target applet may include a second authentication value that is updated with the authentication data when the verification of the authentication data is successful.

According to an embodiment the target applet may include a second authentication key for verifying the authentication data. The target applet may include a second recovery key for verifying recovery data generated from the applet when verification fails. The target applet may include a second authentication value that is updated with the authentication data when the verification of the authentication data is successful.

According to an embodiment, the determining of whether to provide the function of the target applet to the applet by verifying the authentication data may include verifying the authentication data based on the second authentication key for verifying the authentication data in the target applet and the second authentication value included in the target applet.

According to an embodiment, the operating method may further include allowing the target applet and the applet to share an SIO when verification is successful.

According to an embodiment, the operating method may further include generating a predetermined value in the target applet and transmitting the predetermined value to the applet when verification fails. The operating method may further include generating recovery data based on the predetermined value using a first recovery key in the applet. The operating method may further include regenerating the authentication data from the predetermined value or the recovery data based on the first authentication key included in the applet. The operating method may further include transmitting the regenerated authentication data and the recovery data to the target applet.

According to an embodiment, the operating method may further include receiving the regenerated authentication data and the recovery data from the target applet. The operating method may further include determining whether to provide the function of the target applet to the applet through verification based on the recovery data in the target applet.

According to an embodiment, a non-transitory computer-readable storage medium may store one or more programs including instructions that execute any one of the operating methods described above.

The various example embodiments of the present disclosure disclosed herein and the drawings are merely presented to easily describe technical contents of various example embodiments of the present disclosure and help the understanding of them and are not intended to limit the various embodiments. Therefore, all changes or modifications derived from the technical idea of the various embodiments of the present disclosure as well as the various embodiments disclosed herein should be construed to fall within the scope of the disclosure, including the appended claims and their equivalents. It will also be understood that any of the embodiment(s) described herein may be used in conjunction with any other embodiment(s) described herein.

What is claimed is:

1. An electronic device comprising:
at least one host processor comprising processing circuitry; and
a secure element (SE) electrically connected to the at least one host processor,
wherein the SE comprises:
at least one processor, comprising processing circuitry; and
memory storing instructions, wherein at least one processor, individually and/or collectively, is configured to execute the instructions and to cause the electronic device to:
transmit, to an operating system (OS) of the SE, a request for a target applet to be used by an applet;
provide an instance to the applet in response to the request for the target applet;
generate authentication data for the target applet in the applet and transmit the authentication data to the target applet and
determine whether to provide a function of the target applet to the applet by verifying the authentication data in the target applet.

2. The electronic device of claim 1, wherein at least one processor, individually or collectively, is configured to cause the electronic device to: generate the authentication data based on a first authentication value using a first authentication key in the applet and update the first authentication value with the authentication data.

3. The electronic device of claim 1, wherein at least one processor, individually or collectively, is configured to: cause the electronic device to generate a message authentication code (MAC) value for the first authentication value with the first authentication key and determine the MAC value as the authentication data.

4. The electronic device of claim 1, wherein the applet comprises a first authentication key configured to be used to generate the authentication data, a first recovery key configured to be used to generate recovery data based on verification failing, and the first authentication value updated with the authentication data generated by the first authentication key.

5. The electronic device of claim 1, wherein the target applet comprises a second authentication key configured to verify the authentication data, a second recovery key configured to verify the recovery data generated from the applet based on verification failing, and a second authentication value configured to be updated with the authentication data based on verification of the authentication data being successful.

6. The electronic device of claim 1, wherein at least one processor, individually or collectively, is configured to cause the electronic device to: verify the authentication data based on a second authentication key configured to verify the authentication data in the target applet and a second authentication value included in the target applet.

7. The electronic device of claim 1, wherein at least one processor, individually or collectively, is configured to cause the electronic device to allow the target applet and the applet to share a sharable interface object (SIO) based on verification being successful.

8. The electronic device of claim 1, wherein at least one processor, individually or collectively, is configured to cause the electronic device to: based on verification failing, generate a specified value in the target applet and transmit the specified value to the applet, generate recovery data based on the specified value using a first recovery key in the applet, regenerate, in the applet, the authentication data from the specified value or the recovery data based on a first authentication key included in the applet, and transmit the regenerated authentication data and the recovery data to the target applet.

9. The electronic device of claim 1, wherein at least one processor, individually or collectively, is configured to cause the electronic device to: receive, from the target applet, the regenerated authentication data and the recovery data and determine whether to provide the function of the target applet to the applet through verification based on the recovery data in the target applet.

10. The electronic device of claim 8, wherein at least one processor, individually or collectively, is configured to cause the electronic device to: verify, in the target applet, the recovery data based on the specified value and the second recovery key configured to verify the recovery data, update, in the target applet, a second authentication value included in the target applet with the specified value or the recovery data based on verification of the recovery data being successful, and determine whether to provide the function of the target applet to the applet by verifying the regenerated authentication data with the second authentication key and the updated second authentication value.

11. A secure element (SE) comprising:
at least one processor, comprising processing circuitry; and
memory storing instructions, wherein at least one processor, individually or collectively, is configured to execute the instructions and to cause the SE to:
transmit, to an operating system (OS) of the SE, a request for a target applet to be used by an applet;
provide an instance to the applet in response to the request for the target applet;
generate authentication data for the target applet in the applet and transmit the authentication data to the target applet; and
determine whether to provide a function of the target applet to the applet by verifying the authentication data in the target applet.

12. A method of operating an electronic device, the operating method comprising:
transmitting, to an operating system (OS) of a secure element (SE), a request for a target applet to be used by an applet;
providing an instance to the applet in response to the request for the target applet;
generating authentication data for the target applet in the applet and transmitting the authentication data to the target applet; and
determining whether to provide a function of the target applet to the applet by verifying the authentication data in the target applet.

13. The method of claim 12, wherein the transmitting of the authentication data to the target applet comprises:
generating the authentication data based on a first authentication value using a first authentication key in the applet; and
updating the first authentication value with the authentication data.

14. The method of claim 12, wherein the applet comprises a first authentication key used to generate the authentication data, a first recovery key used to generate recovery data based on verification failing, and the first authentication value updated with the authentication data generated by the first authentication key.

15. The method of claim 12, wherein the target applet comprises a second authentication key for verifying the authentication data, a second recovery key for verifying the recovery data generated from the applet based on verification failing, and a second authentication value updated with the authentication data based on verification of the authentication data being successful.

16. The method of claim 12, wherein the determining of whether to provide a function of the target applet to the applet by verifying, in the target applet, the authentication data comprises verifying the authentication data based on a second authentication key for verifying the authentication data and a second authentication value included in the target applet.

17. The method of claim 12, further comprising:
allowing the target applet and the applet to share a sharable interface object (SIO) based on verification being successful.

18. The method of claim 12, further comprising:
based on verification failing, generating a specified value in the target applet and transmitting the specified value to the applet;
generating recovery data based on the specified value using the first recovery key in the applet;
regenerating, in the applet, the authentication data from the specified value or the recovery data based on the first authentication key included in the applet; and
transmitting the regenerated authentication data and the recovery data to the target applet.

19. The method of claim 12, further comprising:
receiving, from the target applet, the regenerated authentication data and the recovery data; and
determining whether to provide the function of the target applet to the applet through verification based on the recovery data in the target applet.

20. A non-transitory computer-readable storage medium storing one or more programs comprising instructions that, when executed by at least one processor, comprising processing circuitry, individually and/or collectively, of an electronic device, cause the electronic device to perform the method of claim 12.
